(19) United States
(12) Patent Application Publication
(10) Pub. No.: US 2010/0244547 A1
(43) Pub. Date: Sep. 30, 2010

(54) BRAKE EQUIPMENT FOR A LAND VEHICLE

(76) Inventors: Leo Gilles, Koblenz (DE); Erwin Michels, Kail (DE); Wilfried Giering, Mendig (DE); Benedikt Ohlig, Vallendar (DE)

Correspondence Address: MACMILLAN, SOBANSKI & TODD, LLC, ONE MARITIME PLAZA - FIFTH FLOOR, 720 WATER STREET, TOLEDO, OH, 43604, US

(21) Appl. No.: 12/665,354

(22) PCT Filed: Jun. 9, 2008
(86) PCT No.: PCT/EP08/04619

§ 371 Date: Jun. 2, 2010

(30) Foreign Application Priority Data
Jun. 19, 2007 (DE) 10 2007 028 070.1

(51) Int. Cl. B60T 8/48

(52) U.S. Cl. 303/3

(57) ABSTRACT

Brake equipment comprising a hydraulic, single- or multi-circuit braking system of a land vehicle having an electric drive for executing a regenerative braking of the land vehicle by means of at least one electric machine in or on the drive train of the vehicle and also a braking of the land vehicle by means of at least one wheel brake. A brake pedal and at least one sensor are used to detect a braking requirement of the driver. A master cylinder is used to supply pressurized hydraulic fluid into at least one brake circuit that supplies at least one wheel brake in accordance with the braking requirement. Associated with at least one brake circuit is an electrohydraulic control unit comprising at least a first connection for hydraulic fluid and at least a second connection for hydraulic fluid. An electronic control unit controls components of the electrohydraulic control unit such as a hydraulic pump and switching valves as a function of a braking requirement and/or sensor signals that represent ambient quantities or characteristic quantities coming from the braking system. A regenerative brake unit has at least a first connection for hydraulic fluid and at least a second connection for hydraulic fluid and is hydraulically coupled into at least one of the brake circuits between the master cylinder and at least one of the wheel brakes. The regenerative brake unit is actuated by the electronic control unit to bring about the effect that, in the event of a regenerative braking operation, the volume of hydraulic fluid corresponding to the braking requirement is not supplied into the wheel brakes, but is stored.

### CROSS-REFERENCE TO RELATED APPLICATIONS

This application is a national stage of International Application No. PCT/EP2008/004619 filed Jun. 9, 2008, the disclosures of which are incorporated herein by reference in entirety, and which claimed priority to German Patent Application No. 10 2007 028 070.1 filed Jun. 19, 2007, the disclosures of which are incorporated herein by reference in entirety.

### BACKGROUND OF THE INVENTION

Brake equipment for a land vehicle is described below. This brake equipment may be brake equipment comprising an electronically controlled, hydraulic, single- or multi-circuit braking system in the brake installation of vehicles that are equipped exclusively, or in addition to an internal combustion engine, with an electric machine in the drive train. An electrohydraulic braking system for such motor vehicles is also described.

In the past the electrical energy needed in motor vehicles was generated practically entirely from fuel (petrol or diesel). However, for example in the case of electrically operated rail-mounted vehicles there is the concept of converting the kinetic energy released during braking, not into frictional heat, but back into electrical (potential) energy. Now, in motor vehicles too, by means of corresponding control devices during braking phases at least some of the braking energy is to be recycled for charging the electric vehicle battery (more precisely, the accumulator).

From EP-A 595 961 and corresponding U.S. Pat. No. 5,472,264, both of which are incorporated by reference herein in entirety, a brake installation for a vehicle having an electric drive is known, which vehicle comprises a conventional braking system provided with hydraulically actuated wheel brakes as well as an electro-regenerative braking system. The electro-regenerative braking system in this case utilizes the electric drive machine(s) of the motor vehicle for braking and for energy recovery during a braking operation.

In this arrangement, during a braking operation the brake force component of the hydraulic wheel brake is adapted to the behaviour of the regenerative brake with a view to optimum energy recovery. For this purpose, from the degree of actuation of the brake pedal the brake force to be set at the driven wheels is determined, while the non-driven wheels are braked in a conventional manner by the hydraulics directly as function of the pedal actuation. For the driven wheels the maximum brake force component of the regenerative brake that is usable in the current operating state is determined from performance quantities and the defined brake force is set by corresponding activation of the drive motor. If the required brake force exceeds the maximum usable brake force component, the excess brake force component is set by the wheel brake. For the driven wheels a decoupling of the hydraulics from the pedal actuation is provided, whilst for the non-driven wheels there is the conventionally direct hydraulic control.

This concept requires complete reconfiguration, redesign and retuning of a brake installation to the respective vehicle in order to equip the vehicle with a regenerative braking functionality. This represents a considerable outlay. This outlay is increased still further by the fact that, whilst currently less than 5% of end users want a regenerative functionality, at least some vehicle manufacturers for marketing reasons intend/“have to” supply it. Consequently, this means that with previous solutions two sets of brake equipment had to be provided for one type of vehicle.

A need now exists for economical measures to configure and functionally develop the brake installation of a vehicle provided with an electric machine in or on the drive train, whereby a variable tuning between the regenerative braking by the electric machine and the wheel brake is achieved in order to achieve a high energy recovery rate with a braking behaviour that is, for the driver, as unaltered as possible.

### BRIEF SUMMARY OF THE INVENTION

As a solution, brake equipment comprising a hydraulic, single- or multi-circuit braking system of a land vehicle with an electric drive is proposed for executing a regenerative braking of the land vehicle by means of at least one electric machine in or on the drive train of the vehicle and also a braking of the land vehicle by means of at least one wheel brake.

Unlike previous concepts, by means of an additional module existing ABS/VSC/ESC brake equipment is expanded practically without modifications into regenerative brake equipment. This allows the vehicle manufacturer to provide a technology, for which there is market demand, within a short time and for a low additional (cost) outlay. This additional module may take the form of an independently manipulable subassembly that expands existing ABS/VSC/ESC brake equipment into regenerative brake equipment.

This is achieved in that a brake pedal and at least one sensor for detecting a braking requirement of the driver are provided. A master cylinder is used to supply pressurized hydraulic fluid into at least one brake circuit supplying at least one wheel brake in accordance with the braking requirement. There is associated with at least one brake circuit an electrohydraulic control unit having at least a first connection for hydraulic fluid and at least a second connection for hydraulic fluid, at least one hydraulic fluid accumulator, at least one electrically controlled hydraulic pump for delivering and pressurizing hydraulic fluid, and a plurality of electrically controlled switching valves.

An electronic control unit is further provided, which controls the components of the electrohydraulic control unit as a function of a braking requirement and/or sensor signals that represent ambient quantities or characteristic quantities coming from the braking system. A regenerative brake unit comprises at least a first connection for hydraulic fluid and at least a second connection for hydraulic fluid. The regenerative brake unit is coupled hydraulically (serially upstream or downstream of the electrohydraulic control unit, viewed from the master cylinder, or in parallel with the electrohydraulic control unit) into at least one of the brake circuits between the master cylinder and at least one of the wheel brakes. The regenerative brake unit is also activated by the electronic control unit in order to achieve the effect that during a regenerative braking operation the volume of hydraulic fluid corresponding to the braking requirement is not supplied into the wheel brakes, but stored in the regenerative brake unit. In this case, the activation of the regenerative brake unit RBU may be effected also by a separate control unit that communicates with the electronic control unit of the electrohydraulic control unit. Ultimately, however, in such an arrangement also the regenerative brake unit is activated by the electronic control unit of the electrohydraulic control unit. In this case, control of the regenerative brake unit RBU may also take priority over the electronic control unit of the electrohydraulic control unit.

On the whole, the arrangement is such that the additional module with the regenerative brake unit takes the form of an add-on unit or plug-in module that is inserted at a predetermined point into the brake circuits without any need for significant modifications at the other components. Thus, the regenerative brake unit may be a separate module that, given an otherwise unaltered topology/layout of the brake circuits, may be inserted or integrated therein. Thus, even brake equipment already in mass production may with a minimum outlay be expanded into regenerative brake equipment.

The brake equipment may have a vacuum brake booster that supports the brake pedal actuation of the driver. However, forms of construction are also possible, in which the actuation of the brake pedal acts directly and without boosting upon the master cylinder. If the brake equipment has a vacuum brake booster, a simulation of the brake pedal sensation—which is described in detail below—entails less of an outlay because in this case the combination of vacuum brake booster and master cylinder has a crucial formative influence on the brake pedal sensation for the driver.

The regenerative brake unit has a first regenerative brake operating state to be controlled, in which the regenerative brake unit prevents a supply of hydraulic fluid into the wheel brakes corresponding to the driver's requirement and instead brings about a storage of the hydraulic fluid. It moreover has a second changeover operating state to be controlled, in which the regenerative brake unit changes over from a regenerative braking to an electrohydraulic braking, wherein in the changeover operating state hydraulic fluid is supplied into the wheel brakes in accordance with the driver's requirement and, during this process, hydraulic fluid stored in a hydraulic fluid accumulator is released into the respective brake circuit.

The regenerative brake unit may comprise a hydraulic fluid accumulator that is preloaded by a spring in order to exert a compliant counterforce against inflowing hydraulic fluid.

The hydraulic fluid accumulator in the regenerative brake unit may also be hydraulically connected in series with a switching valve that has an electromagnetically settable let-through position and a spring-actuated blocking position.

The hydraulic fluid accumulator in the regenerative brake unit may moreover be hydraulically connectable to (and/or disconnectable from) an electrically adjustable pump for controlled filling and/or emptying of the hydraulic fluid accumulator. This pump may be a pump in the electro-hydraulic control unit ESC or a pump provided in the regenerative brake unit RBU.

By means of the hydraulic fluid accumulator the hydraulic fluid may be made available in terms of time and location directly to the electrohydraulic control unit, so that even a creeping change from a regenerative braking operation to a hydraulic friction braking operation that is not detectable as such by the driver may be executed very efficiently.

In a first variant of the brake equipment, the regenerative brake unit may be coupled into at least one brake circuit between the master cylinder and the electrohydraulic control unit, wherein the first connection for hydraulic fluid of the regenerative brake unit is connected to a connection of the master cylinder, and the second connection for hydraulic fluid of the regenerative brake unit is connected to the first connection of the electrohydraulic control unit. The second connection for hydraulic fluid of the electrohydraulic control unit is connected to one of the wheel brakes. The electronic control unit in this case (directly or indirectly) controls both the components of the regenerative brake unit and the components of the electrohydraulic control unit as a function of a braking requirement and/or sensor signals that represent ambient quantities or characteristic quantities coming from the braking system and under these circumstances transfers the regenerative brake unit in accordance with requirements from a regenerative brake operating state to a changeover operating state (and/or back again).

In a further variant of the brake equipment, the regenerative brake unit may be coupled into at least one brake circuit between the master cylinder and the electrohydraulic control unit, wherein the first connection for hydraulic fluid of the regenerative brake unit is connected to a connection of the master cylinder, and the second connection for hydraulic fluid of the regenerative brake unit is connected to the first connection of the electrohydraulic control unit. The second connection for hydraulic fluid of the electrohydraulic control unit is connected to one of the wheel brakes, and the regenerative brake unit has a third connection for hydraulic fluid that is connected to one of the wheel brakes. Here too, the electronic control unit (directly or indirectly) controls both the components of the regenerative brake unit and the components of the electrohydraulic control unit as a function of a braking requirement and/or sensor signals that represent ambient quantities or characteristic quantities coming from the braking system and under these circumstances transfers the regenerative brake unit in accordance with requirements from a regenerative brake operating state to a changeover operating state (and/or back again).

In another variant of the brake equipment, the regenerative brake unit may be coupled into at least one brake circuit between the master cylinder and the electrohydraulic control unit, wherein the first connection for hydraulic fluid of the regenerative brake unit is connected to a connection of the master cylinder, and the second connection for hydraulic fluid of the regenerative brake unit is connected to the first connection of the electrohydraulic control unit. The second connection for hydraulic fluid of the electrohydraulic control unit is connected to one of the wheel brakes. The regenerative brake unit has a third connection for hydraulic fluid that is connected to an inlet side of the hydraulic pump in the electrohydraulic control unit. Here too, the electronic control unit (directly or indirectly) controls both the components of the regenerative brake unit and the components of the electrohydraulic control unit as a function of a braking requirement and/or sensor signals that represent ambient quantities or characteristic quantities coming from the braking system and under these circumstances transfers the regenerative brake unit in accordance with requirements from a regenerative brake operating state to a changeover operating state (and/or back again).

In another variant of the brake equipment, the regenerative brake unit may be coupled into at least one brake circuit between the master cylinder and the electrohydraulic control unit. The first connection for hydraulic fluid of the electrohydraulic control unit is connected to a connection of the master cylinder. The second connection for hydraulic fluid of the electrohydraulic control unit is connected to the first connection for hydraulic fluid of the regenerative brake unit. The second connection for hydraulic fluid of the regenerative brake unit is connected to one of the wheel brakes. Here too, the electronic control unit (directly or indirectly) controls both the components of the regenerative brake unit and the components of the electrohydraulic control unit as a function of a braking requirement and/or sensor signals that represent ambient quantities or characteristic quantities coming from the braking system and under these circumstances transfers the regenerative brake unit in accordance with requirements from a regenerative brake operating state to a changeover operating state (and/or back again).

The energy thus regenerated (=recovered) is not utilized to unconditionally fully charge the accumulator(s) of the motor vehicle. Rather, a charging condition of the accumulators for stationary consumption and the starting ability of the motor vehicle is determined as a function of relevant ambient conditions and adjusted. A charging of the accumulators beyond this is effected only in energetically advantageous driving phases (=recuperation phases) when no fuel is consumed for this purpose. If the accumulators in these recuperation phases have been charged beyond the starting-ability/stationary-consumption charge, electrical energy is available, which may be supplied directly to the vehicle electrical system without having to be summoned up by the (fuel-operated) generator. This surplus capacity may be used to remove less or no energy from the generator, which is otherwise to be operated by means of fuel, thereby leading to reduced fuel consumption.

By virtue of this solution (or solution variants), given the use of an only slightly expanded or modified conventional electrohydraulic brake installation with wheel brakes, the potential of regenerative braking in electric land vehicles, in vehicles with a hybrid drive, or in motor vehicles with an adequately dimensioned starter generator in or on the drive train is optimally utilized. The electric machines recover as much energy as possible during braking. Braking requirements that exceed the regenerative braking are covered by the wheel brake. When the electrical system of the vehicle is switched off, the electrohydraulic braking installation acts upon all of the braked vehicle wheels. As a result, the operational safety of the motor vehicle during braking is guaranteed.

A brake line proceeding from the master cylinder may branch into two lines leading to the wheel brakes at the wheels, in which inlet valves that have a spring-actuated let-through position and an electromagnetically settable blocking position are disposed.

Between the inlet valves and the wheel brakes one return line may proceed from each respective brake line, in each of which return lines an outlet valve having a spring-actuated blocking position and an electro-magnetically settable let-through position is disposed.

The return lines may be brought together in one return line, to which the hydraulic fluid accumulator is connected.

The electrically controlled pump may be connected at its intake side to the return line and at its outlet side by a delivery line to the brake line between the master cylinder and the inlet valve.

In the line between the storage chamber and the pump a non-return valve may be disposed, which prevents hydraulic fluid from flowing off into the accumulator in the event of a driver-actuated braking intervention and when the switching valve is open.

Leading to the intake side of the pump there may be an intake line, in which an intake control valve having a spring-actuated blocking position and an electro-magnetically settable let-through position may be situated, which may be connected by a line to the brake line.

In the brake line a shut-off valve may be situated, which is bypassed by a non-return valve, wherein the shut-off valve has a spring-actuated let-through position and an electromagnetically settable blocking position and the non-return valve, given a braking situation that is independent of a braking requirement, allows hydraulic fluid coming from the wheel brakes to flow to the master cylinder even in an electromagnetically set blocking position of the shut-off valve.

In the event of a regenerative braking operation, the regenerative brake unit does not allow any hydraulic fluid through. In the event of a normal braking operation, on the other hand, a first switching valve of the regenerative brake unit is blocked so that hydraulic fluid may flow off from the brake circuit towards the master cylinder or the hydraulic reservoir thereof or may be displaced from the master cylinder into the brake circuit.

During normal operation the valves may be situated in their non-actuated basic position, so that the inlet valves are open and the outlet valves are closed.

In the ABS situation, the corresponding valves may be opened or closed in a controlled manner and the pump may be actuated in order to build up or reduce or maintain pressure in the relevant wheel brakes.

Further features, properties, advantages and possible modifications of the brake equipment clear to the person skilled in the art from the following description, in which reference is made to the accompanying drawings.

### BRIEF DESCRIPTION OF THE DRAWINGS

Components or subassemblies that are identical, comparable or act in a comparable manner are provided with identical symbols and/or reference characters in the figures and are described as a rule only once.

FIG. 1 shows a diagrammatic overview representation of a first variant of a hydraulic braking system in a hydraulic brake installation with ABS/ASC function.

FIG. 2 shows a diagrammatic detail representation of the hydraulic brake installation of FIG. 1.

FIG. 3 shows a diagrammatic overview representation of a further variant of a hydraulic braking system in a hydraulic brake installation with ABS/ASC function.

FIG. 4 shows a diagrammatic overview representation of a further variant of a hydraulic braking system in a hydraulic brake installation with ABS/ASC function.

FIG. 5 shows a diagrammatic overview representation of a further variant of a hydraulic braking system in a hydraulic brake installation with ABS/ASC function.

### DETAILED DESCRIPTION OF THE INVENTION

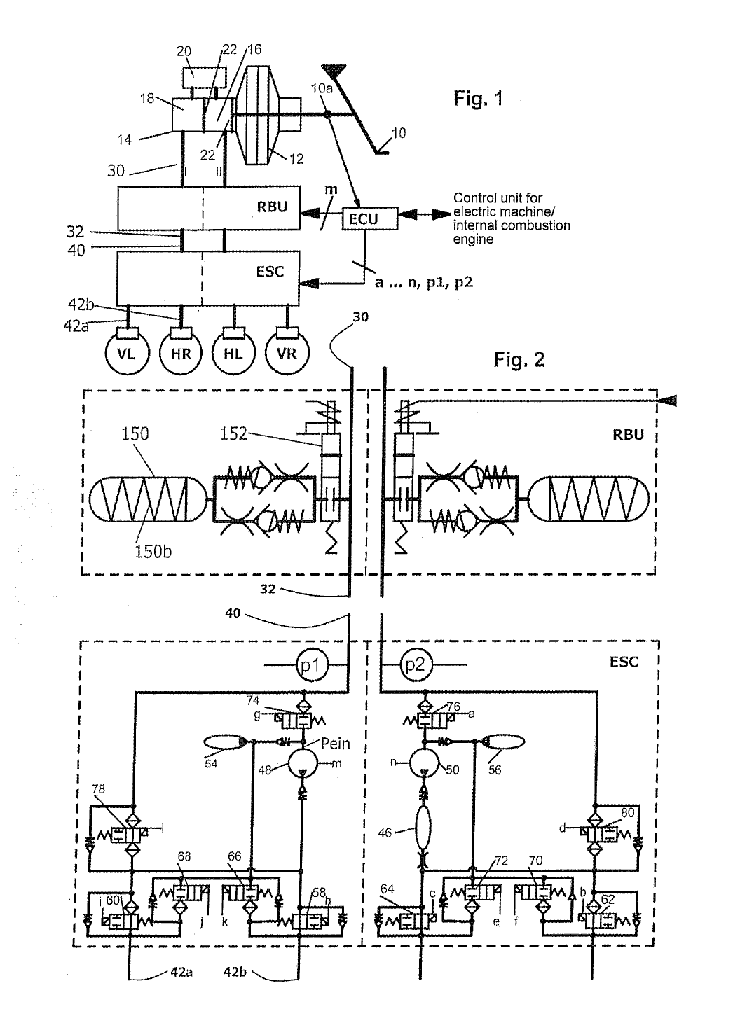

FIGS. 1 and 2 are diagrammatic overview and detail representations respectively of a hydraulic braking system with crosswise brake force distribution, in a hydraulic brake installation with ESC/ABS/ASC function, in which the concept is realized. It is however self-evident that other types of brake force distribution (for example an H-type distribution) are also possible. Thus, for example in a motor vehicle driven at the rear axle the regenerative functionality may be realized at the rear axle only. At any rate, the changeover functionality is provided at least at the axle that (also) has an electric machine for driving/braking the motor vehicle.

A brake pedal 10 to be actuated by a driver acts upon an input element of an (optional) pneumatic brake booster 12, the output element of which actuates a push rod of a master cylinder 14. The master cylinder 14 has a first cylinder chamber 16 and a second cylinder chamber 18, both of which communicate with a hydraulic reservoir 20. The two cylinder chambers 16, 18 are separated from one another by an intermediate piston 22 and upon actuation of the brake pedal 10 each supply one of two brake circuits I, II, which comprise a regenerative brake unit RBU and an electro-hydraulic control unit ESC. On the brake pedal 10 for carrying out regenerative braking at least one measuring device 10a is provided, which delivers a measurement of the actuating travel x and/or the force of actuation of the brake pedal by the driver (=braking requirement). The following description relates to only the one—in FIG. 1 left—brake circuit I, while the other brake circuit II, because it is functionally and structurally identical to the brake circuit I, is left out of the discussion.

The electrohydraulic control unit ESC and the regenerative brake unit RBU are designed in each case as separately manipulable constructional units that are to be coupled to one another merely by their hydraulic connections. An electronic control unit ECU is further provided, which controls the components of the electrohydraulic control unit ESC and of the regenerative brake unit RBU as a function of a braking requirement and/or sensor signals that reproduce ambient quantities or characteristic quantities coming from the braking system.

The two brake circuits I, II in the case of crosswise brake force distribution comprise, on the one hand, the brake cylinder of the left rear wheel and the brake cylinder of the right front wheel and, on the other hand, the brake cylinder of the left front wheel and the brake cylinder of the right rear wheel. Besides the wheel brake cylinders, the associated brake disks are represented. Provided in the electrohydraulic control unit are damper chambers, fluid feed pumps, storage chambers, inlet valves and outlet valves as well as pilot valves and high-pressure switching valves. The electrohydraulic control unit is designed so as to enable a wheel-specific control of the switching valves derived from signals of wheel speed sensors and pressure sensors. A brake-circuit-specific control is achievable for example by triggering of the pilot valves the high-pressure switching valves or the return pumps. The trigger signals required for this purpose are provided by the ECU.

The brake circuits I, II have a common regenerative brake unit RBU, which has a first connection 30 for hydraulic fluid and at least a second connection 32 for hydraulic fluid that is hydraulically connected to the first connection 30. The regenerative brake unit RBU is hydraulically coupled into the brake circuits I, II between the master cylinder 14 and the wheel brakes VL, HR, HL, VR, wherein the brake circuits I, II further have an electro-hydraulic control unit ESC, which for each brake circuit has a first connection 40—facing the master cylinder—for hydraulic fluid and two second connections 42a, 42b—facing the wheel brakes—for hydraulic fluid.

A brake line, which proceeds from the first connection 40 of the electrohydraulic control unit ESC and at which a pressure sensor p1 acquires the prevailing hydraulic pressure and generates a corresponding signal for the electronic control unit ECU, branches into two paths leading to the wheel brakes VL and HR. Provided in the two paths are inlet valves 58 and/or 60, which have a spring-actuated let-through position and an electromagnetically settable blocking position. Between the inlet valves and the wheel brakes VL, HR one return line proceeds from each brake line. Disposed in each of these return lines is an outlet valve 66, 68. The two outlet valves 66, 68 have a spring-actuated blocking position and an electro-magnetically settable let-through position. The two return lines are combined into one return line, to which a low-pressure storage chamber 54 is connected. The brake circuit moreover comprises a pump 48, which is driven by an electric motor and generates high pressure. This pump 48 is connected at its intake side to the return line. At its delivery side the pump 48 is connected by a delivery line to the brake line between the master cylinder and the inlet valves 58, 60.

The pump 48 may be a (radial) piston pump having up to six or more pistons, the electric motor of which receives a pulse-width-modulated (PWM) operating current. The PWM operating current may in this case have a minimum pulse width of ca. 15-45 microseconds, for example 25 μsec (20 kHz⁻¹).

There is further disposed in the line between the storage chamber 54 and the inlet side of the pump 48 a non-return valve that, when the outlet valve 66 or 68 is open, prevents the development of a vacuum in the wheel brake cylinders VL, HR (see FIG. 1). Leading at the intake side to the pump 48 there is in addition to the return line an intake line, in which an intake control valve 74 having a spring-actuated blocking position and an electro-magnetically settable let-through position is situated. This intake control valve 74 is connected by a line to the brake line.

The regenerative brake unit RBU is coupled in between the brake line proceeding from the master cylinder 14 and the input 40 of the electrohydraulic control unit ESC.

The regenerative brake unit RBU has a hydraulic fluid accumulator 150 and a first switching valve 152 connected in series, wherein the switching valve 152 connects the hydraulic fluid accumulator 150 to the connecting line between the first and the second connection 30, 32 of the regenerative brake unit RBU. The first switching valve 152 of the regenerative brake unit RBU has an electro-magnetically settable let-through position and a spring-actuated blocking position. Thus, between the master cylinder 14 and the electrohydraulic control unit ESC a releasable or blockable storage chamber is provided, in which the volume of hydraulic fluid corresponding to the braking requirement in the event of a regenerative braking operation is not supplied to the brakes, but may flow into the hydraulic fluid accumulator 150. From there it may within the framework of a hydraulic friction braking operation be directly retrieved practically without any time delay, should the regenerative braking operation be insufficient to apply the required braking torque “to the road”.

In this case, the hydraulic fluid accumulator 150 is loaded by a spring arrangement 150b in order—in the case of regenerative braking—to exert a compliant counterforce against hydraulic fluid coming out of the master cylinder 14. The spring arrangement 150b may be formed by a plurality of springs equipped with different spring properties (spring constants) in order to convey to the driver during regenerative braking phases—described in detail further below—a “braking sensation” that is as realistic as possible. This braking sensation may be finely tuned by means of additional restrictors, for example in each case one in the inlet path and one in the outlet path with an adapted net orifice. Given an arrangement comprising a vacuum brake booster and a master cylinder connected downstream thereof, these two components however at least at the start of a braking operation determine the pedal behaviour and the pedal sensation presented to the driver to such an extent that at least as a rule additional restrictors in the inlet path and in the outlet path with an adapted net orifice etc. should not be necessary.

Situated in the brake line in the electrohydraulic control unit ESC is a shut-off valve 78, 80 that is bypassed by a pressure control valve. The shut-off valve 78, 80 has a spring-actuated blocking position and an electro-magnetically settable let-through position. In a braking situation that is independent of a braking requirement, for example in a slip control situation, the pressure control valve allows hydraulic fluid coming from the wheel brakes to flow to the master cylinder 14 even in an electro-magnetically set blocking position of the shut-off valve 78, 80.

During normal operation the electrically actuable valves are in their non-actuated basic position. This means that the inlet valves are open and the outlet valves are closed. Consequently, the corresponding wheel brakes are loaded with the pressure initiated by the driver through actuation of the pedal. In the ABS situation the corresponding valves are opened or closed in a controlled manner and the pump is actuated in order to build up or reduce or maintain pressure in the relevant wheel brake(s).

If the driven wheels of the vehicle have too high a drive slip, i.e. a slip control situation exists, the corresponding pilot valve is switched into its blocking position and the intake valve is switched into its let-through position. By activating the pump 48 in the electrohydraulic control unit ESC, without pedal actuation hydraulic fluid is taken in from the hydraulic reservoir 54 of the electrohydraulic control unit ESC and introduced via the open inlet valve into the relevant wheel brake cylinder(s). As a result, pressure may be built up in the wheel brakes independently of the brake pedal actuation. The pressure reduction is effected by opening the outlet valves, closing the intake valves and opening the pilot valves.

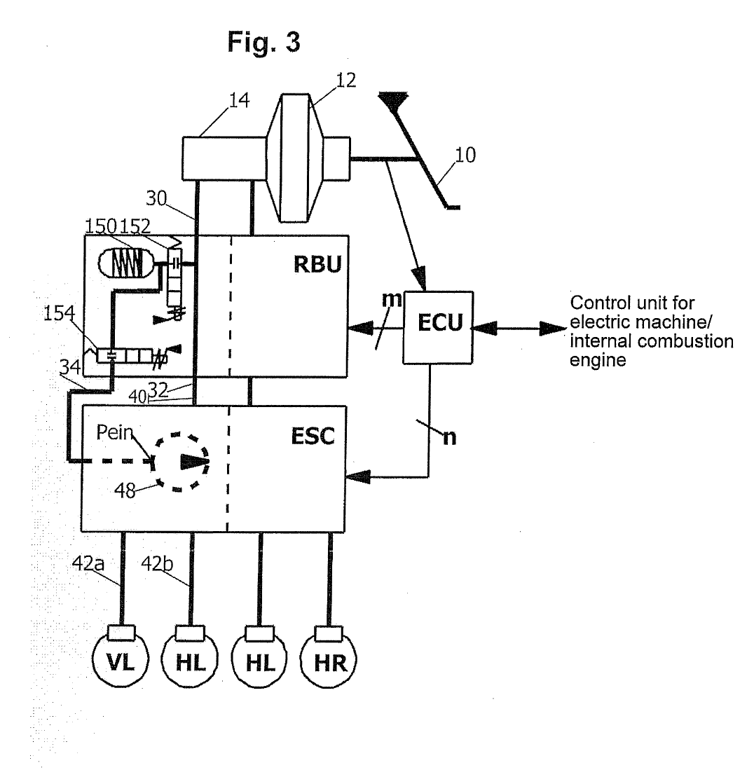

FIG. 3 shows a variant of a braking system, in which the electrohydraulic control unit ESC compared to the arrangement of FIG. 2 is unaltered apart from a further connecting line to the pump inlet Pₑᵢₙ of the pump 48. Compared to the arrangement of FIG. 2 the regenerative brake unit RBU has no throttles or restrictors. It is however understood that, in this variant too, (from comparable standpoints as in the variant of FIG. 2) the throttles and restrictors may be provided. Between the hydraulic fluid accumulator 150 of the regenerative brake unit RBU and the first switching valve 152 connected in series thereto a hydraulic line branches off to a second switching valve 154 that leads to a third connection 34 of the regenerative brake unit RBU. The second switching valve 154 of the regenerative brake unit RBU has a spring-actuated blocking position and an electromagnetically settable let-through position.

The third connection 34 of the regenerative brake unit RBU leads to a connection of the electrohydraulic control unit ESC that is connected to the pump intake Pₑᵢₙ of the pump 48 of the electrohydraulic control unit ESC. Thus, in the event of regenerative braking the second switching valve 154 of the regenerative brake unit RBU may remain closed, while the first switching valve 152 of the regenerative brake unit RBU is opened in order to convey the hydraulic fluid coming from the master cylinder 14 into the hydraulic fluid accumulator 150 of the regenerative brake unit RBU. At the same time, in the event of regenerative braking the intake control valve 74 and the shut-off valve 78 in the electrohydraulic control unit ESC are closed.

In order to make hydraulic fluid rapidly available to the pump 48 of the electrohydraulic control unit ESC for a driver-independent brake actuation, after (or alternatively to terminate) a regenerative braking the second switching valve 154 of the regenerative brake unit RBU may be opened so that hydraulic fluid forced out of the hydraulic fluid accumulator 150—by the spring 150b thereof—is present at the pump intake Pₑᵢₙ and may be delivered by the switching valves of the electrohydraulic control unit ESC in a controlled manner into the wheel brakes.

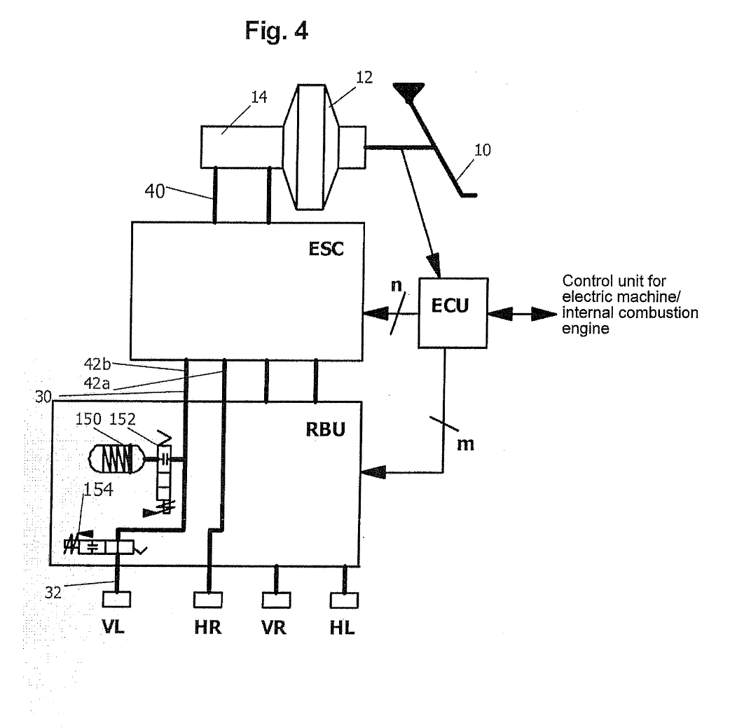

FIG. 4 shows a variant of a braking system, in which the electrohydraulic control unit ESC is connected by its first connection 40 directly to the master cylinder 14 and the regenerative brake unit RBU is connected by its first connection 30 to the second connection 42b of the electrohydraulic control unit ESC. In other words, the regenerative brake unit RBU is connected between the electrohydraulic control unit ESC and the wheel brakes, while the electrohydraulic control unit ESC is connected directly to the master cylinder 14.

The functionality of the electrohydraulic control unit ESC remains in this case completely unaltered; the regenerative brake unit RBU in the event of a regenerative braking operation receives the hydraulic fluid instead of the wheel brakes. In the variant shown in FIG. 4, a wheel brake (VL) has a storage chamber 150 for receiving hydraulic fluid instead of the wheel brake. The other wheel brake of this brake circuit (HR) has no storage chamber. In this case, the front axle also has an electric machine capable of energy recovery, while the rear axle is to be braked in a conventional manner. It is self-evident that this configuration is also transposable, i.e. the rear axle has an electric machine capable of energy recovery, while the front axle is to be braked in a conventional manner.

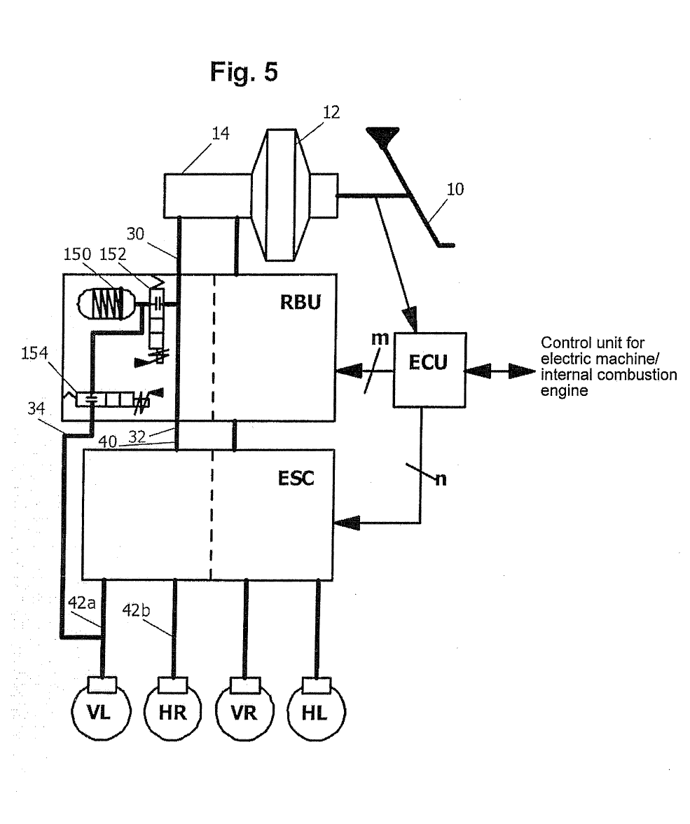

FIG. 5 shows a variant of a braking system, in which the electrohydraulic control unit ESC compared to the arrangement of FIGS. 2 and 4 is unaltered. The regenerative brake unit RBU compared to the arrangement of FIG. 2 has no throttles or restrictors. Between the hydraulic fluid accumulator 150 of the regenerative brake unit RBU and the first switching valve 152 connected in series thereto a hydraulic line branches off to a second switching valve 154 of the regenerative brake unit RBU that leads to a third connection 34 of the regenerative brake unit RBU. The second switching valve 154 of the regenerative brake unit RBU has a spring-actuated blocking position and an electromagnetically settable let-through position.

The third connection 34 of the regenerative brake unit RBU leads to the second connection 42a of the electrohydraulic control unit ESC that is connected to one of the wheel brakes VL. Thus, in the event of regenerative braking the second switching valve 154 of the regenerative brake unit RBU may remain closed, while the first switching valve 152 of the regenerative brake unit RBU is opened in order to convey the hydraulic fluid coming from the master cylinder 14 into the hydraulic fluid accumulator 150 of the regenerative brake unit RBU. At the same time, during regenerative braking the intake control valve 74 and the shut-off valve 78 in the electrohydraulic control unit ESC are closed.

During normal brake operation, in this variant, the first switching valve 152 and the second switching valve 154 of the regenerative brake unit RBU are decided [sic], so that the regenerative brake unit RBU is deactivated and the electrohydraulic control unit ESC may function in its unmodified way. In order to make hydraulic fluid from the hydraulic fluid accumulator 150 of the regenerative brake unit RBU available to the electrohydraulic control unit ESC for example for driver-independent braking operations, the electrohydraulic control unit ESC goes into pressure reduction state and the second switching valve 154 of the regenerative brake unit RBU opens. Hydraulic fluid may then be pumped out of the hydraulic fluid accumulator 150 of the regenerative brake unit RBU.

Besides the hydraulically actuated wheel brakes that are described above and represented in the figures, in an electric and/or hybrid vehicle a regenerative braking is possible by means of one or more electric machines that are used to drive the motor vehicle. In this case, the electric machine or machines operating as (a) generator(s) is/are activated to charge the accumulator(s). In this case, for controlling the electric machine(s) as a rule a separate control unit is provided. This is data-communicating connection to the control unit that controls the hydraulic brake installation.

This control unit for the hydraulic brake installation receives a measurement of the brake pedal actuation, quantities of the wheel speeds of the vehicle wheels and the pressure in the individual vehicle brakes as well as the pressure at the outlet of the master cylinder. A, for example serial, bus is further used as a link to the engine control unit to receive a quantity representing the braking torque set by the regenerative brake and to output a quantity representing the braking torque to be set. Output control lines are further provided for controlling the diverse valves and the pump.

The aim in the case of electric and/or hybrid vehicles is to recover as much as possible of the energy that is released during braking. As the regenerative braking by means of the drive machine of the vehicle is insufficient to cover all braking requirements of the vehicle, the vehicle is additionally equipped with a wheel brake. The regenerative braking and the wheel brake are to be tuned to one another in such a way that as much energy as possible may be recovered, while at the same time the other functions of a brake installation (ABS, VSC, TC, ESP, etc.) are equally available.

In the control unit that controls the brake installation the braking operations from wheel brake and regenerative brake are coordinated. For this purpose, at least one signal representing the brake pedal actuation is supplied to the control unit. If the electrical system is in operation, the electric machine(s) are able to brake the vehicle. At the start of a normal braking operation (i.e. not an emergency- or panic braking operation), upon actuation of the brake pedal the valves in the hydraulic brake installation are actuated in such a way that there occurs in the wheel brake cylinders no or only a slight brake pressure build-up that leads to no or no significant hydraulic braking effect. Rather, a regenerative braking operation is initiated. For this purpose, the first switching valve 152 of the regenerative brake unit RBU is moved into its electromagnetically set blocking position. The intake control valve 78 of the electrohydraulic control unit ESC is also moved into its electromagnetically set blocking position. Furthermore, the switching valve 152 of the regenerative brake unit RBU that is connected in series to the hydraulic fluid accumulator 150 is moved into its spring-actuated let-through position.

The actuation of the brake pedal by the driver allows hydraulic fluid to flow into the hydraulic fluid accumulator 150 of the regenerative brake unit RBU, while the spring 150b of the hydraulic fluid accumulator 150 is compressed. From the actuation of the brake pedal and optionally further performance quantities the braking requirement of the driver is derived. This is converted to a setpoint braking torque, which is then converted in the control unit of the electric machine to corresponding operating parameters for the electric machine. As soon as the storage chamber 150 of the regenerative brake unit RBU is full without the braking requirement being terminated or decreasing, then, in the event of an on-going braking requirement, in addition to the regenerative braking brake pressure is built up in the hydraulic brakes and hence a superimposed braking by the wheel brake in accordance with the braking requirement is achieved.

If the braking requirement decreases or is terminated before the storage chamber 150 of the regenerative brake unit RBU is completely full, the pressure reduction of the storage chamber is effected in such a way that the intake control valve 78 in the electrohydraulic control unit ESC takes up or remains in its let-through position. The first switching valve 152 of the regenerative brake unit RBU that is connected in series to the hydraulic fluid accumulator 150 moreover takes up or remains in its let-through position.

By virtue of the previously described solution, the pedal characteristic familiar to the driver is retained. In particular, in the regenerative braking range despite the low brake pressure no pedal behaviour other than the expected pedal behaviour is generated.

When braking in hazardous or borderline situations, however, a uniform and/or purposefully preselectable brake force distribution is advantageous. For this reason, the control unit does not open the valves if such situations are identified at the start of braking. The wheel brake immediately starts to brake, so that the defined brake force distribution is guaranteed. Such braking situations are for example so-called panic braking operations, which may be derived i.a. from the speed of actuation of the brake pedal.

There are moreover operating situations, in which the regenerative braking component has to be reduced. This is the case for example if the battery is full, the charging power over time is too high or, as a result of a variation of the vehicle speed, the dependence of the engine braking torque upon the vehicle speed has an influence upon the overall braking. In these operating situations the overall braking would reduce if the driver did not vary the pedal travel. As it may be provided that the control unit of the electric drive feeds back the instantaneously set engine torque to the brake control unit, in such situations the outlet valves, if they are still open, are closed and the pump is started. As a result, the volume of fluid that has accumulated in the storage chamber is returned to the brake circuit. Thus, without a pedal travel variation the wheel brake component may be increased.

To prevent this increasing the required pedal force at the driver's foot it may be provided that in operating situations, in which the wheel brake component is increased, in addition to the pump 48 the pilot valve of the electrohydraulic control unit ESC is also actuated so that the brake pressure in the wheel may be increased without the counterforce at the pedal increasing.

If none of these special operating situations exists, then the switching valves are closed in accordance with a relationship, stored in the control unit, between the degree of filling of the storage chamber 150 of the electrohydraulic control unit ESC and the pedal travel. The valves are in this case closed if a specific pedal travel corresponding to a specific degree of filling of the storage chamber 150 of the regenerative brake unit RBU is exceeded.

Another procedure is such that in the event of regenerative braking the storage chamber 150 of the regenerative brake unit RBU is completely filled. If, when the storage chamber 150 is full, the anti-locking braking system of the wheel brake deploys, then because of the full storage chamber a pressure reduction may proceed only slowly. For this reason, by means of the control unit the drive motor or motors are switched for a short time to drive in order to compensate the excessive braking torque of the wheels. In the open state of the valves, the resistance to the pedal is in this case determined by the spring 150b in the storage chamber 150. This spring is as a rule weakly dimensioned so that in a locking situation the brake pressure may be reduced to low values. If during the regenerative braking phase the storage chamber spring represents the sole resistance to the pedal, in some embodiments the spring may possibly be of a stronger design. This means however that in the anti-locking situation the brake pressure cannot be reduced to low values. In this situation too, the drive machines of the electric vehicle may be switched to drive in order to compensate the excessive braking torque of the wheel brake. Alternatively, the hardness of the resetting springs at the brake pedal 10 or in the master cylinder 14 may be raised in order to increase the pedal counterforce during the regenerative braking phase.

The previously described brake equipment is used for merely illustrative purposes and not for the purpose of restricting the concept or the realizations thereof. Various changes and modifications to the brake equipment are possible, including the transfer of aspects of one of the illustrated variants to another of the illustrated variants, while still making use of the concept, the realizations thereof or equivalents thereof.

In accordance with the provisions of the patent statutes, the principle and mode of operation of this invention have been explained and illustrated in its preferred embodiment. However, it must be understood that this invention may be practiced otherwise than as specifically explained and illustrated without departing from its spirit or scope.

1. Brake equipment comprising a hydraulic, single- or multi-circuit braking system of a land vehicle having an electric drive for executing a regenerative braking of the land vehicle by means of at least one electric machine in or on the drive train of the vehicle and also a braking of the land vehicle by means of at least one wheel brake, wherein
a brake pedal (10) and at least one sensor (10a) for detecting a braking requirement of the driver are provided,
a master cylinder (14) is provided for supplying pressurized hydraulic fluid into at least one brake circuit (I, II) that supplies at least one wheel brake (VL, HR, VR, HL) in accordance with the braking requirement, wherein
associated with at least one brake circuit (I, II) is an electrohydraulic control unit (ESC) comprising
at least a first connection (40) for hydraulic fluid and at least a second connection (42a, 42b) for hydraulic fluid,
an electronic control unit (ECU) is provided that controls components of the electrohydraulic control unit (ESC) such as a hydraulic pump and switching valves as a function of a braking requirement and/or sensor signals that represent ambient quantities or characteristic quantities coming from the braking system, and
a regenerative brake unit (RBU) that
has at least a first connection (30) for hydraulic fluid, at least a second connection (32) for hydraulic fluid, and a hydraulic fluid accumulator (150)
is hydraulically coupled into at least one of the brake circuits (I, II) between the master cylinder (14) and at least one of the wheel brakes (VL, HR, VR, HL),
characterized in that
the electronic control unit (ECU) controls both the components of the regenerative brake unit (RBU) and the components of the electrohydraulic control unit (ESC) as a function of a braking requirement and/or sensor signals that represent ambient quantities or characteristic quantities coming from the braking system in order to bring about the effect that, in the event of a regenerative braking operation, the volume of hydraulic fluid corresponding to the braking requirement is not supplied into the wheel brakes (VL, HR, VR, HL), but is stored, and
one of the connections for hydraulic fluid of the regenerative brake unit (RBU) is connected to at least one of the wheel brakes (VL, HR, VR, HL).

2. Brake equipment according to claim 1, characterized in that the electrohydraulic control unit (ESC)
comprises at least one low-pressure storage chamber (54, 56),
at least one electrically controlled hydraulic pump (48, 50) for delivering and pressurizing hydraulic fluid, and
a plurality of electrically controlled switching valves (58 . . . 80).

3. Brake equipment according to claim 1 or 2, characterized in that the regenerative brake unit (RBU) and the electrohydraulic control unit (ESC)
have a first regenerative brake operating state to be controlled, in which the regenerative brake unit (RBU) and the electrohydraulic control unit (ESC) prevent a supply of hydraulic fluid into the wheel brakes (VL, HR, VR, HL) corresponding to the driver's requirement and bring about a storage of the hydraulic fluid instead, and
have a second changeover operating state to be controlled, in which the regenerative brake unit (RBU) and the electrohydraulic control unit (ESC) change over from a regenerative braking to an electrohydraulic braking, wherein in the changeover operating state hydraulic fluid is supplied into the wheel brakes (VL, HR, VR, HL) in accordance with the driver's requirement and, during this process, hydraulic fluid is released into the respective brake circuit (I, II).

4. Brake equipment according to one of claims 1 to 3, characterized in that the hydraulic fluid accumulator (150) is preloaded with a spring (150b) in order to exert a compliant counterforce against inflowing hydraulic fluid.

5. Brake equipment according to one of claims 1 to 4, characterized in that the hydraulic fluid accumulator (150) in the regenerative brake unit (RBU) is connected in series with a first switching valve (152) that has an electromagnetically settable let-through position and a spring-actuated blocking position.

6. Brake equipment according to one of claims 1 to 5, characterized in that the hydraulic fluid accumulator (150) in the regenerative brake unit (RBU) is to be connected to an electrically settable pump for the controlled filling and/or emptying of the hydraulic fluid accumulator (150).

7. Brake equipment according to one of claims 1 to 6, characterized in that the regenerative brake unit (RBU) is coupled into at least one brake circuit (I, II) between the master cylinder (14) and the electrohydraulic control unit (ESC), wherein
the first connection (30) for hydraulic fluid of the regenerative brake unit (RBU) is connected to a connection of the master cylinder (14),
the second connection (32) for hydraulic fluid of the regenerative brake unit (RBU) is connected to the first connection (40) of the electrohydraulic control unit (ESC), and
the third connection (34) for hydraulic fluid of the regenerative brake unit (RBU) is connected to at least one of the wheel brakes (VL, HR, VR, HL),
the second connection (42a, 42b) for hydraulic brake fluid of the electrohydraulic control unit (ESC) is connected to one of the wheel brakes (VL, HR, VR, HL), and
the electronic control unit (ECU) controls both the components of the regenerative brake unit (RBU) and the components of the electrohydraulic control unit (ESC) as a function of a braking requirement and/or sensor signals that represent ambient quantities or characteristic quantities coming from the braking system and, under these circumstances, switches the regenerative brake unit (RBU) to and/or fro between the regenerative brake operating state and the changeover operating state in accordance with requirements.

8. Brake equipment according to claim 7, wherein the switching valve (152) connects the hydraulic fluid accumulator (150) to the connecting line between the first and the second connection (30, 32) of the regenerative brake unit (RBU).

9. Brake equipment according to one of claim 7 or 8, characterized in that in the event of a regenerative braking operation an intake control valve (74) and a shut-off valve (78) in the electrohydraulic control unit (ESC) are closed.

10. Brake equipment according to one of claims 7 to 9, characterized in that in the regenerative brake unit (RBU) between the hydraulic fluid accumulator (150) and the first switching valve (152) connected in series therewith a hydraulic line branches off to a second switching valve (154) that blocks or releases the third connection (34).

11. Brake equipment according to claim 10, characterized in that the second switching valve (154) has a spring-actuated blocking position and an electromagnetically settable let-through position.

12. Brake equipment according to one of claim 10 or 11, characterized in that, in the event of a regenerative braking, the second switching valve (154) of the regenerative brake unit (RBU) remains closed, while the first switching valve (152) of the regenerative brake unit (RBU) is open in order to convey the hydraulic fluid coming from the master cylinder (14) into the hydraulic fluid accumulator (150) of the regenerative brake unit (RBU).

13. Brake equipment according to one of claim 10 or 11, characterized in that after a regenerative braking or to terminate a regenerative braking the second switching valve (154) of the regenerative braking unit (RBU) is opened so that hydraulic fluid forced out of the hydraulic fluid accumulator (150) is present at one of the wheel brakes (VL, HR, VR, HL) and the second connection (42a, 42b) for hydraulic fluid of the electrohydraulic control unit (ESC).

14. Brake equipment according to one of claims 1 to 6, characterized in that the electrohydraulic control unit (ESC) is coupled into at least one brake circuit (I, II) between the master cylinder (14) and the regenerative brake unit (RBU), wherein
the first connection (40) for hydraulic fluid of the electrohydraulic control unit (ESC) is connected to a connection of the master cylinder (14), and
the second connection (42a, 42b) for hydraulic fluid of the electrohydraulic control unit (ESC) is connected to the first connection (30) for hydraulic fluid of the regenerative brake unit (RBU),
the second connection (32) for hydraulic fluid of the regenerative brake unit (RBU) is connected to one of the wheel brakes (VL, HR), and
the electronic control unit (ECU) controls both the components of the regenerative brake unit (RBU) and the components of the electrohydraulic control unit (ESC) as a function of a braking requirement and/or sensor signals that represent ambient quantities or characteristic quantities coming from the braking system and, under these circumstances, switches the regenerative brake unit (RBU) to and/or fro between the regenerative brake operating state and the changeover operating state in accordance with requirements.

15. Brake equipment according to claim 14, characterized in that in the regenerative brake unit (RBU) there is a second switching valve (154) that blocks or releases the second connection (32).

16. Brake equipment according to claim 15, characterized in that the second switching valve (154) has a spring-actuated let-through position and an electromagnetically settable blocking position.

17. Brake equipment according to one of claim 15 or 16, characterized in that, in the event of a regenerative braking, the second switching valve (154) of the regenerative brake unit (RBU) remains closed, while the first switching valve (152) of the regenerative brake unit (RBU) is open in order to convey the hydraulic fluid coming from the master cylinder (14) into the hydraulic fluid accumulator (150) of the regenerative brake unit (RBU).

18. Brake equipment according to one of claim 15 or 16, characterized in that after a regenerative braking or to terminate a regenerative braking the second switching valve (154) of the regenerative brake unit (RBU) is opened so that hydraulic fluid forced out of the hydraulic fluid accumulator (150) is present at at least one of the wheel brakes (VL, HR, VR, HL).

19. Brake unit according to one of the preceding claims, characterized in that a brake line proceeding from the master cylinder (14) branches into two lines to the wheel brakes (VL, HR, VR, HL) at the wheels, in which inlet valves (58, 60, 62, 64) having a spring-actuated let-through position and an electromagnetically settable blocking position are disposed.

20. Brake unit according to the preceding claim, characterized in that between the inlet valves (58, 60, 62, 64) and the wheel brakes (VL, HR, VR, HL) there proceeds from the respective brake line one return line each, in which in each case an outlet valve (66, 68, 70, 72) having a spring-actuated blocking position and an electromagnetically settable let-through position is disposed.

21. Brake unit according to the preceding claim, characterized in that the return lines are brought together in one return line, to which the low-pressure storage chamber (54, 56) is connected.

22. Brake unit according to the preceding claim, characterized in that the electrically controlled hydraulic pump (48, 50) is connected at its intake side to the return line and at its outlet side by a delivery line to the brake line between the master cylinder and the inlet valves (58, 60, 62, 64).

23. Brake unit according to the preceding claim, characterized in that disposed in the line between the low-pressure storage chamber (54, 56) and the electrically controlled hydraulic pump (48, 50) is a non-return valve that prevents hydraulic fluid from flowing off into the low-pressure storage chamber (54, 56) in the event of a driver-actuated braking intervention and when the intake control valve (74, 76) is open.

24. Brake unit according to the preceding claim, characterized in that leading to the intake side of the electrically controlled hydraulic pump (48, 50) is an intake line, in which an intake control valve (74, 76) that has a spring-actuated blocking position and an electromagnetically settable let-through position is situated, which is connected to the brake line via a line.

25. Brake unit according to the preceding claim, characterized in that situated in the brake line is a shut-off valve (78, 80) that is bypassed by a pressure control valve, wherein the shut-off valve (78, 80) has a spring-actuated let-through position and an electromagnetically settable blocking position and the pressure control valve, in a braking situation that is independent of a braking requirement, allows hydraulic fluid coming from the wheel brakes (VL, HR, VR, HL) to flow to the master cylinder (14) even in the case of an electromagnetically set blocking position of the shut-off valve (78, 80).

26. Brake unit according to one of the preceding claims, characterized in that during normal operation the valves are in their non-actuated basic position so that the inlet valves (58, 60, 62, 64) are open and the outlet valves (66, 68, 70, 72) are closed.

27. Brake unit according to one of the preceding claims, characterized in that, in the ABS case, the appropriate valves are opened or closed in a controlled manner and the electrically controlled hydraulic pump (48, 50) is actuated in order to build up or to reduce or maintain pressure in the respective wheel brake or brakes (VL, HR, VR, HL).

28. Brake unit according to one of the preceding claims, characterized in that the electrically controlled hydraulic pump (48, 50) in the electrohydraulic control unit is a reciprocating pump that has six pistons and whose electric drive motor is supplied with a pulse-width-modulated (PWM) operating current that has a minimum pulse width of between 15 and 45 μsec.
